(19) United States
(12) Patent Application Publication
(10) Pub. No.: US 2006/0059704 A1
(43) Pub. Date: Mar. 23, 2006

(54) Distance measuring and recording apparatus and method

(76) Inventor: David Derek Wilson, Palmyra, VA (US)

Correspondence Address: David D. Wilson, 55 Ponderosa Ln, Palmyra, VA, 22963, US

(21) Appl. No.: 10/943,417

(22) Filed: Sep. 17, 2004

(51) Int. Cl. G01B 3/10

(52) U.S. Cl. 33/761

(57) ABSTRACT

A distance measuring and recording device uses a conventional distance measuring device of any type available now or in the future having attached thereto a voice recording device equipped with means of convenient recording, playback and clearing of a user's statements of measurements taken and other relevant information for reference or re-recording at a later time.

### BACKGROUND OF THE INVENTION

It is very often necessary both for private individuals and those engaged in commercial or governmental activities to take measurements of distance or length. Without limitation, examples of such activities range from construction to the investigation of crime or accident scenes, from maintenance and repair to interior decorating. In almost all these cases, it is necessary to record accurately for future reference the measurement taken, and often a series on one occasion of many different successive distance measurements. Hitherto, the most common recording method has been a notepad and ballpoint or pencil, but all too often the location at, and conditions under, which the measurements are taken preclude immediate recording by such a method, and errors of human memory and its limited short-term capacity arise. For instance, measurements may be taken in wet weather, from the top of a ladder, in a crawl space, or in many other situations where writing on a notepad is difficult, dangerous, or impossible. This present invention is directed to providing in almost any situation and under almost any conditions an economical and simple means of taking and recording accurately at the actual time it is taken a distance or length measurement or series of such measurements for future reference and other information. Other methods of recording measurements have been the subjects of U.S. patents, but the present invention is the first to employ a recorder of a user's voice, usually the most convenient and versatile medium in almost all measuring conditions.

### BRIEF SUMMARY OF THE INVENTION

This invention is directed to the taking and immediate, convenient recording of measurements of distance or length, and accordingly comprises a distance measuring device capable of voluntary actuation by a user of the invention and, integrally attached to such device, a voice recorder capable of recording and playback of the user's voice at the user's will. The measuring device may be of any type known to the art at present or to be so known in the future, which in use registers the desired distance or length in standard units familiar to, or chosen by, the user. Without limitation, examples of such a measuring device include a conventional distance measuring tape capable of extension from and retraction into a case, and any device relying for its distance measuring capabilities on sonic reflection or radiation such as radar, infra-red or laser. In most cases, it is probable, but not inherently necessary, that the measuring device with integrally attached voice recorder be readily portable by the user. The voice recorder, also in a case, may be of any type known to the art at present or to be so known in the future, adapted in size and form for integral attachment of its case to a part of the measuring device in such a position that both the voice recorder and the measuring device are capable of easy actuation by the user. Such actuation of the voice recorder may be, for example, by conventional record, stop, playback, and clear button-operated contacts or even by coded or uncoded voice actuation or a combination of both. It will thus be seen that this invention is in the novel combination in one useful apparatus of two main conventional elements, which are: a measuring device, and a voice recorder capable of recording for future reference the user's oral statements, which may be, for example without limitation, of measurements as they are made available to the user by the measuring device, and of other relevant information the user may deem desirable. The voice recorder may be for example of the chip type, which is readily available in small sizes, driven by small batteries, and yet capable of several minutes clear recording and playback, possibly with background noise suppression, and warning means for indicating that the recording capacity is about to be exceeded, and operable in any language or accent in any conditions in which a measuring device is operable, thus avoiding the obvious difficulties of recording with a notepad and pencil, or with other inventions published hitherto.

### BRIEF DESCRIPTION OF THE DRAWINGS

FIG. 1 is an elevation view of the preferred embodiment of the distance measuring and recording device according to this invention, showing a measuring tape case with an encased voice recorder integrally attached, the view being taken axially with respect to the rolled tape when partially extended, the retracted portion being concealed within the case.

FIG. 2 is a view from the right-hand side of FIG. 1, showing the voice recorder case attached to the tape case, and the measuring tape partially extended.

FIG. 3 is a sectional view taken on the line AA of FIG. 2 and showing in conventional form components of the voice recorder, including its battery, loudspeaker, and contacts.

FIG. 4 shows an embodiment of the invention in which the voice recorder is attachable to and detachable from the measuring element, in this case, by way of an example, by means of a interconnecting twistlock device having male tangs integrally attached to the recorder and female receptors integrally attached to the measuring device, the recorder and measuring element being shown apart so as to illustrate the disconnected twistlock device clearly.

FIG. 5 shows a version of the present invention comprising a tapeless measuring device capable of displaying measurements on a numerical display screen.

### DETAILED DESCRIPTION OF THE INVENTION

The utility of this invention lies in its enabling by novel means a user thereof at the user's will to record by voice distance measurements at the times such measurements are taken by the user, and is particularly evident when recording methods hitherto available are difficult to use, for instance, because of adverse conditions at the measuring site. Accordingly, this invention comprises a novel integral combination of two devices, a distance measuring device and a voice recorder, each of which are already well known in their respective and widely separate fields. It will be appreciated that there has long been an obvious worldwide need, for the sake of accuracy and convenience, for the ability of this invention to record measurements at the time and place of measurement even in conditions too adverse for the use of recording devices hitherto available. In spite of such a need, however, no other apparatus comprising the combination of elements of the present invention, and satisfying that need, has apparently been introduced. Other inventions intended to record measurements have been the subject of U.S. patents, notably U.S. Pat. No. 5,983,514 Lindsey, and U.S. Pat. No. 4,882,850 Lindsey, but, in contrast to the present invention, neither of those inventions by themselves alone permit voice recording of measurements read by the user immediately after the time such measurements are taken, and both of those inventions require manual dexterity to a certain degree in excess of that required by the present invention. Moreover, both those earlier inventions lack the ability inherent in the voice recording ability of the present invention to record such descriptive voice statements that the user may deem desirable in addition to those purely of measurements. It therefore appears that the present invention displays all the qualities of utility, novelty, and nonobviousness.

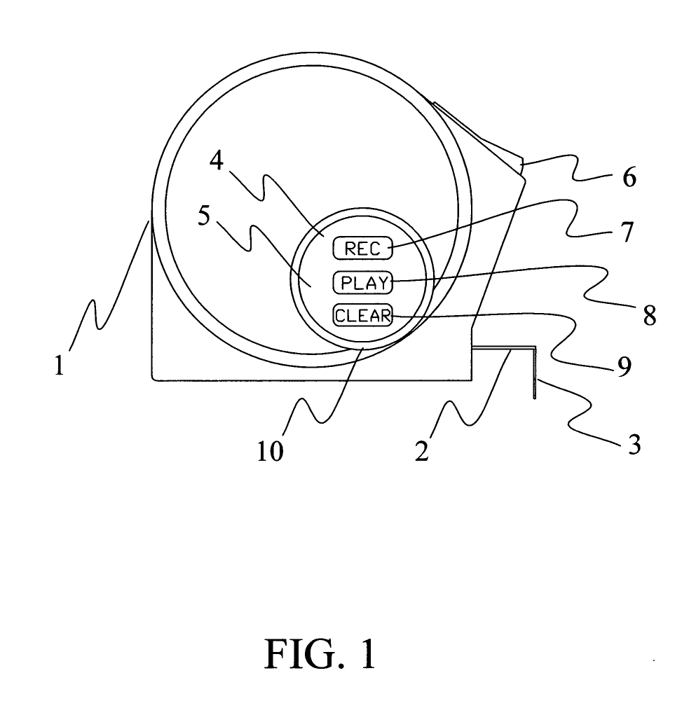

For the widest general use the distance measuring device that is an element of the combination forming a preferred version of the present invention is most likely to be a conventional distance measuring tape capable of extension from and retraction into a case, and marked with standard distance measurement units. Accordingly, FIGS. 1, 2, 3 and 4 illustrate such a measuring device as an element of the invention.

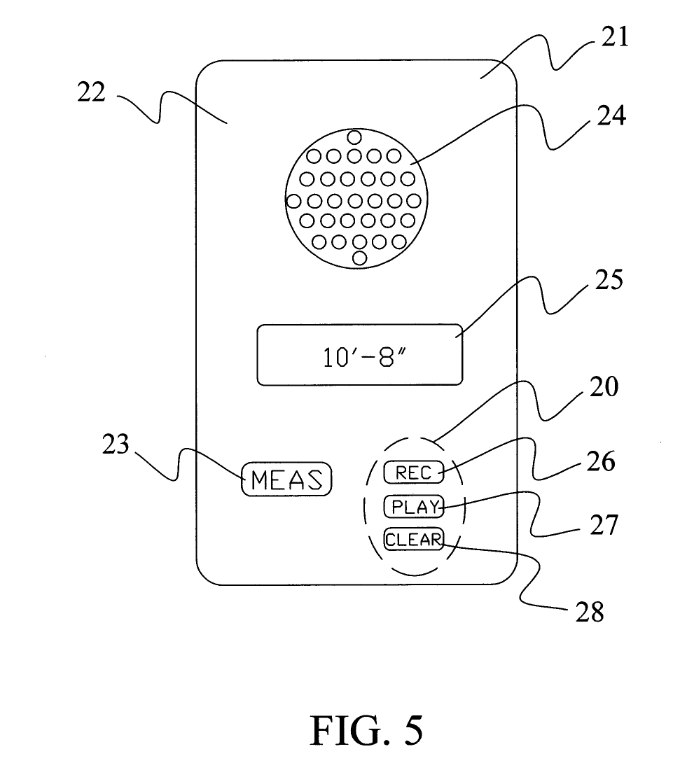

FIG. 1 shows a preferred embodiment of the invention in which, integrally attached to case 1, which contains a majority portion of partially extended measuring tape 2, in turn equipped with tip 3, is case 4 of encased voice recording device 5, which may be of the chip type, or other compact type. It is desirable in versions of the invention in which the measuring device is of the type illustrated in FIGS. 1, 2, 3 and 4, that is, comprising measuring tape 2 retractable into case 1, that the case 4 should totally enclose recording device 5 and be attached to rather than being molded into case 1, so that on, for instance, a construction site, foreign matter that would commonly be introduced into case 1 by retraction of measuring tape 2 would not also be introduced into the recorder 5. As will be seen in FIG. 5, that isolation of the interior of the voice recorder 5 from that of the measuring device 2 may not be necessary or even desirable in versions of this invention comprising other types of measuring device. Also shown in FIG. 1 is sliding button 6 for a conventional tape locking means, for locking measuring tape 2 when tip 3 is extended to the point the distance of which is to be measured, so that the measurement may be conveniently read by the user. As previously stated, measuring tape 2 with tip 3 and recording device 5, except when in combination in the present invention, are well-known, conventional items, which may be available in many designs and configurations, but which need no further descriptions of their functional components or modes of operation, except where illustrative of this invention. It will be appreciated that the meaning of “voice recording means” or “voice recording device” herein of necessity implies also an ability to play back the voice recorded, since a means or device which could record but not play back would be of no practical use. The voice recorder may be, for example, of the chip type, which is readily available in small sizes, driven by small batteries, and yet capable of several minutes clear recording and playback, possibly with background noise suppression, and warning means for indicating that the recording capacity is about to be exceeded, and operable in any language or accent in any conditions in which a measuring device is operable, thus avoiding the obvious difficulties of recording with a notepad and pencil, or with other inventions published hitherto.

With reference again to FIG. 1, a method of using the invention when comprising measuring tape 2 is as follows: first, user extends measuring tape 2 from the point from which a distance measurement is to be taken until tip 3 is at the point to which such measurement is to be taken; second, user locks tape 2 in position by operating sliding button 6 or other means, if any; third, user reads the distance measurement from tape 2; fourth, user depresses recording button 7, which actuates the recording function of voice recorder 4, and is conveniently labeled to shown that it is indeed the button to be depressed for recording to proceed; fifth, while continuing to depress button 7, user orally states the amount of the measurement and any other information deemed necessary; sixth, user releases button 7 to terminate the recording process; seventh, user repeats the immediately preceding process first through sixth, with respect to any other measurements deemed necessary on that occasion; eighth, when convenient, user plays back the recordings of measurements and other information, in actuating the playback function by depressing button 8, which actuates the playback function of voice recorder 5, and is conveniently labeled to show that it is indeed the button to be depressed for playback to proceed; ninth, user terminates playback by releasing button 8, but consistent with the recording of additional measurements and information and with the total recording time of which voice recorder 5 is capable, user may play back recordings as many times as required; tenth, user actuates immediate clearing of unwanted recordings from voice recorder 5 by depressing button 9, conveniently labeled to show that it is indeed the button to be depressed for clearing to proceed. Upon playback the measurements and information may be transferred to other media, for example without limitation to drawings, notebooks, and specifications, and may also be re-recorded on sound recorders.

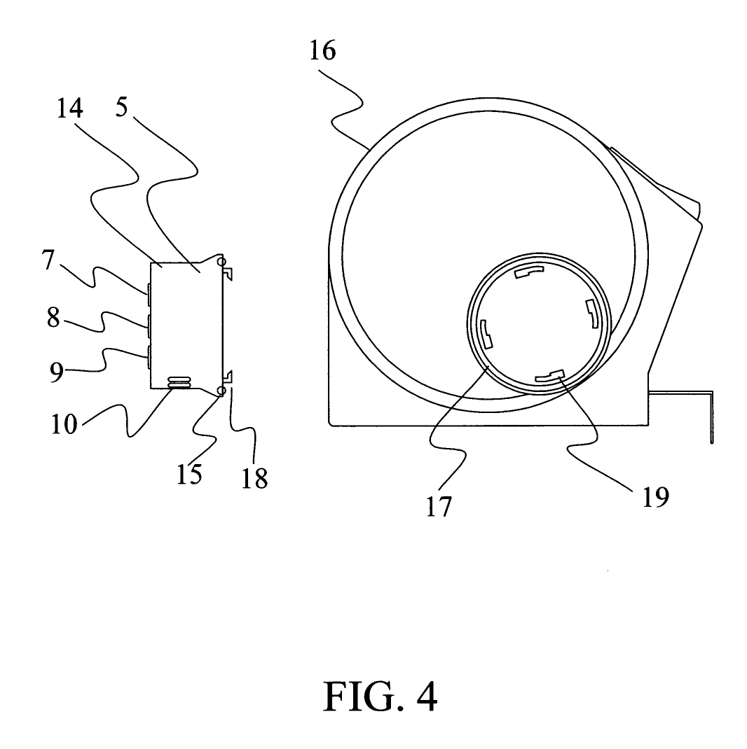

In addition, where the original recording may be required to be preserved for evidence, or where the recording time for one voice recorder may be exceeded and multiple voice recorders therefore become necessary, for instance, either the whole apparatus may be preserved without the recording's being cleared, which is preferable, or the voice recorder element of the combination may be made attachable and detachable from the measurement means by a conventional mutually interconnective push-and-twist twistlock fitting, for example, between the cases of the measuring device and the voice recorder. Accordingly, FIG. 4 shows such an embodiment with the recorder 5 separated from measuring device 2, in which case 14 is a modification of case 4 of FIG. 1, in that case 14 has O-ring 15 of compressible and elastic material and male twistlock tangs 18, and case 16 is a modification of case 1 of FIG. 1, in that case 16 has O-ring groove 17 and female twistlock receptors 19. To attach case 14 to case 16, case 14 is positioned so that O-ring 15 fits into O-ring groove 17, and case 14 is then pushed and twisted so that twistlock tangs 18 engage twistlock receptors 19, the purpose of O-ring 17 being by its compressible and elastic characteristics to hold tangs 18 and receptors 19 together when engaged. To detach case 14 from case 16, the reverse procedure is followed.

The voice recorder may also be of the type where, instead of, or in combination with the record, playback, and clear buttons, the recorder may be actuated and operated by the user's appropriate oral commands, which may in separate embodiments of this invention be capable or incapable of being coded, or arranged for response only to an authorized user's voice. These types of recorder are adequately illustrated by voice recorder 5 in the drawings, since the external and sectional appearance would not differ from that shown.

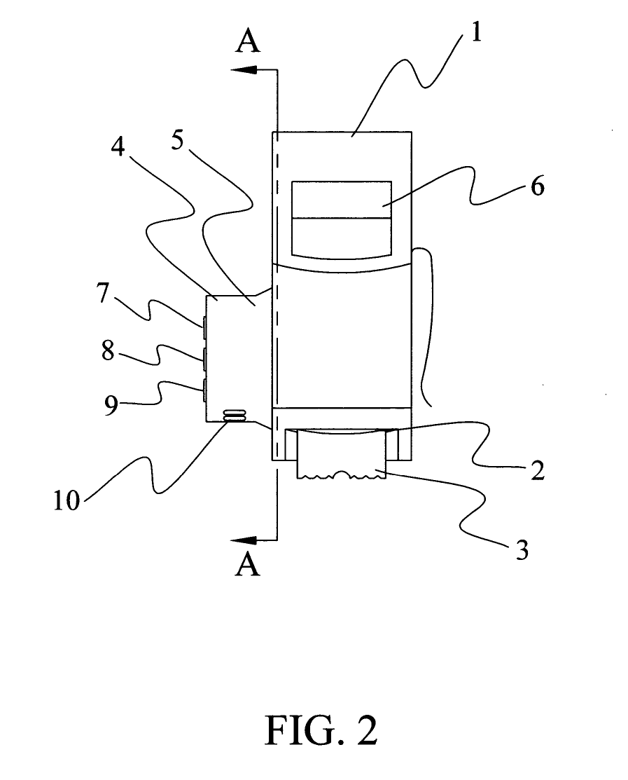

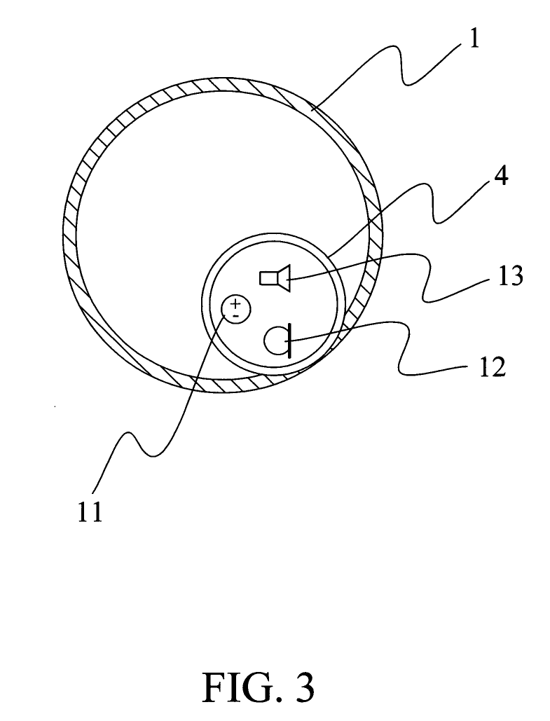

In FIGS. 1 and 2 case-openings 10 in recorder case 4 provide openings for voice recorder 5 to receive voice input and project playback output, but case-openings 10 may be in any convenient location in case 4 to suit the configuration of recording and playback means contained within case 4, which configuration is conventionally represented in the sectional view of FIG. 3, where battery 11, microphone 12, and loudspeaker 13 are shown by conventional symbols within case 4.

As an illustration of an embodiment of this invention comprising a different type of distance measuring device from the above-described tape, FIG. 5 shows recording device 20, which may be internally similar to recording device 5, integrally attached within case 21 of otherwise conventional sonic distance measuring device 22, in which measure-command button 23, when depressed by a user, causes a sonic signal to be emitted from projector port 24, which signal is reflected from the object, commonly a flat surface such as a wall, whose distance is to be measured, and, received back through projector port 24, causes the distance to be registered in conventional units on display screen 25, which in said FIG. 5 is shown as registering a distance of ten feet and eight inches, as an example. In FIG. 5, recorder 20 is shown having similar actuation buttons to those shown in recorder 5 in FIGS. 1 and 2, that is, for recording 26, for playback 27, and for clearing a recording 28. As noted above, in the description of the embodiment of this invention as illustrated in FIGS. 1, 2, 3, and 4, the measuring device of FIG. 5 does not require recorder 20 to be separately encased from measuring device 22, since the operation of measuring device 22 should not in normal use, even on a construction site, be prone to introduce foreign matter into case 21.

The measuring device 22 as described, and as shown in FIG. 5, employs a sonic signal, but any distance measuring device using other means, such as, without limitation, lasers or microwave transmissions may also be used as the distance measuring device that forms an element of the combination which is this invention, without departing from the utility or novelty thereof.

The foregoing description of the invention has been directed primarily to a particular preferred embodiment in accordance with applicable law and for the purposes of explanation and illustration. It will be apparent, however, to those skilled in the art that modifications and changes in the specifically described apparatus and method may be made within the scope and true spirit of the present invention, in addition to the alternative versions of the preferred embodiment described above. The appended claims are intended to cover such modifications and changes.

What is claimed is:

1. A distance measuring and recording apparatus comprising:
a distance measuring device having a case; and
integrally attached to said case, an encased voice recording device having means available to a user at the user's will of initiating, terminating, and clearing a recording process.

2. An apparatus as claimed in claim 1 in which the encased voice recording device and the case of the distance measuring device have mutually interconnective means for enabling at user's will attachment of the encased voice recording device to, and detachment of the encased voice recording device from, the case of the distance measuring device.

3. An apparatus as claimed in claim 1 in which the distance measuring device is an extensible and retractable measuring tape graduated in measuring units.

4. An apparatus as claimed in claim 1 in which the distance measuring device is an encased distance measuring device by which distance is measured by sonic means and registered on a numerical display screen.

5. An apparatus as claimed in claim 1 in which the encased voice recording device is detachable from, and re-attachable to, the case of the distance measuring device.

6. An apparatus as claimed in claim 1 in which the means available to a user at the user's will of initiating, terminating, and clearing a recording process has manually-operable button-connected contacts enabling a user to initiate, terminate and clear a recording already made by said recording device.

7. An apparatus as claimed in claim 1 in which the means available to a user at the user's will of initiating, terminating, and clearing a recording process has integral means of enabling a user by the user's oral commands to initiate, terminate and clear recordings by said recording device.

8. An apparatus as claimed in claim 5 in which the means available to a user at the user's will of initiating, terminating, and clearing a recording process has integral facilities enabling a user by a combination of manually-operable button-connected contacts and user's oral commands to initiate, terminate and clear recordings by said recording device.

9. A method of measuring and recording distances by using an apparatus having distance measuring and recording means, which comprises:
measuring a distance by the measuring means of the apparatus;
reading the distance as registered by said measuring means;
initiating recording by the recording means of the apparatus;
orally stating the registered distance and other relevant information into said recording means;
terminating recording by the recording means of the apparatus;
repeating the above-described actions of this claim with respect to as many different distances as are required to be measured;
initiating playback by the recording means of the apparatus;
listening to said playback; and
transferring a record of the registered distances and other relevant information into another medium as desired.
